(19) United States
(12) Patent Application Publication
(10) Pub. No.: US 2008/0083067 A1
(43) Pub. Date: Apr. 10, 2008

(54) Bed and absorbent pad

(76) Inventor: Lynn Ann Wheeldon-Glazener, Arlington, TX (US)

Correspondence Address: Lynn Wheeldon-Glazener, 1200 Dawn Dr., Arlington, TX, 76010-1924, US

(21) Appl. No.: 11/906,267

(22) Filed: Oct. 1, 2007

Related U.S. Application Data
(60) Provisional application No. 60/850,332, filed on Oct. 10, 2006.
(60) Provisional application No. 60/849,757, filed on Oct. 6, 2006.

(51) Int. Cl. A61G 7/02; A61G 9/00

(52) U.S. Cl. 5/604; 5/695

(57) ABSTRACT

This invention comprises products which are needed for home use to care for adults who are incontinent or have decreased mobility. Caring for an elderly or disabled family member can be difficult. Hospital beds are expensive, and may not be affordable to some people. The bed of this invention will be made of molded plastic, which will make it more affordable than a hospital bed. The air mattress sections will aid in turning, toileting, and provide back support when sitting up in bed. The removable side rails will provide safety during use. The foam mattress will have a recessed area which will help to keep a bed-pad in place during use. The disposable bed-pad designed to fit the recessed area of the foam mattress is different than disposable bed-pads currently available. It will have a top layer which has polystyrene beads mixed with fibers for wicking and treated with a surfactant. This will allow fluid to flow through the top layer into the absorptive layer below, keeping the skin relatively dry. It will also allow for air flow to the skin, which is important for evaporation of moisture. Disposable bed pads currently available serve mainly to protect the bed from urine. They become quickly saturated. Adult diapers also become saturated during the night, and then moisture is held in next to the skin. The plastic sheet covering the outside of diapers holds in wetness, which protects the bed, but is not healthy for the skin. The bed will include a bed-pan which has a shape different from bed-pans currently in use. This bed-pan is designed specifically for use with the bed. Bed-pans currently in use are usually placed and removed from the side, which causes frequent spills during removal. They are also uncomfortable to use. This bed will have an air mattress under the foam mattress with inflatable sections that will aid with turning and placement of the bed-pan. With the air mattress sections on each side of the bed-pan inflated, the body will be slightly elevated and the bed-pan can be grasped by the handle and pulled forward for easy removal without turning to the side. The foam mattress will have a cover which is soft to the touch and water resistant. It will have a sewn-in pocket which fits the recessed area of the foam mattress and the bed-pad. It will be removable and washable.

### RELATED U.S. APPLICATION DATA

APPL No. 60/850,332 . . . October 2006

APPL No. 60/849,757 . . . October 2006

### REFERENCES CITED

U.S. Pat. No. 3,612,055 October 1971 Mesek et al.

U.S. Pat. No. 4,692,161 September 1987 Puletti et al.

### BACKGROUND

This invention generally relates to products used for absorption of body fluids as in medical or hygienic absorbents. Examples are adult diapers and bed pads.

Adults normally produce an amount of urine that can saturate a portion of the diaper, this portion most likely being the area under the buttocks, especially during hours of sleep. This can cause skin break-down. The water-impervious backing sheet that most diapers contain holds fluid in and prevents good air circulation to the skin. Disposable bed pads available in retail stores serve mainly to protect the bed from urine. They are not effective in keeping the skin dry.

Caring for an adult with incontinence or limited mobility can be difficult in the home setting. Medical beds which provide comfort and safety are expensive.

### SUMMARY

A bed for home care of adults with urinary incontinence or reduced mobility. Said bed will have a frame and removable side rails made of molded plastic. It will have a foam mattress with a recessed area shaped for placement of a bed pad. It will have a cover that has a sewn-in pocket with the same size and shape as the recessed area of the foam mattress. The cover will be soft to the touch, water resistant, removable, and washable. There will be an air mattress placed under the foam mattress. The air mattress will have sections that can be inflated separately to aide with turning, toileting, and back support. A bed-pan will be included with the bed. It will have a size and shape that promotes comfort and ease of use.

Disposable bed pads which fit into the recessed area of the foam mattress will be sold separately. The pads will have a layer of polystyrene beads mixed with short fibers for wicking enclosed in a porous facing layer with a quilted pattern. Under the beads will be a layer comprising a highly porous, loosely compacted, cellulosic fibrous batt with a fluid impervious backing. During use, urine will flow through the layer of beads to the batt below. The area of the pad which contacts the skin will stay relatively dry and the beads will provide a cushion for bony areas of the body such as the coccyx.

### DESCRIPTION OF DRAWINGS

FIG. 1

5 is a section of foam 80 inches long and 34 inches wide with a 12 inch by 12 inch cut-out section in the middle. It is ½ inch thick.

FIG. 2

4 is a section of foam 80 inches long and 34 inches wide. It is 2 inches thick.

FIG. 3

1 is the head area of the bed frame and refers to the anterior surface area of the bed frame

2 is the foot area of the bed frame and refers to the posterior surface of the bed frame.

3 is a leg attached to the bed frame.

6A and 6B are round 13/16 inch in diameter holes that extend down 5¼ inches through the bed frame.

7A and 7B are round 13/16 inch in diameter holes that extend down 5¼ inches through the bed frame.

8A and 8B are round 13/16 inch in diameter holes that extend down 5¼ inches through the bed frame.

9A and 9B are round 13/16 inch in diameter holes that extend down through the bed frame which is 3½ inches thick at this point.

10A and 10B are round 13/16 inch in diameter holes that extend down through the bed frame, which is 3½ inches thick at this point.

FIG. 4

1 is the head area of the molded plastic bed frame, and refers to the anterior surface of the bed.

6A and 6B are holes round 13/16 inch in diameter that extend down 5¼ inches through the bed frame. They are placed at 11/32 inch from the head area and 9 13/32 inches from each side surface of the frame.

7A is a round 13/16 inch in diameter hole that extends down through the bed frame 5¼ inches. It is placed 17/32 inch from the head area and 11/32 inch from the outer side surface of the frame.

7B is a round 13/16 inch in diameter hole that extends down through the bed frame 5¼ inches. It is placed 20 17/32 inches from the head area and 11/32 inch from the outer side surface of the frame.

8A is a round 13/16 inch in diameter hole that extends down through the bed frame 5¼ inches. It is placed 17/32 inch from the head area and 11/32 inch from the outer side surface of the frame.

8B is a round 13/16 inch in diameter hole that extends down through the bed frame 5¼ inches. It is placed 20 17/32 inches from the head area and 11/32 inch from the outer side surface of the frame.

9A is a round 13/16 inch in diameter hole that extends down through the entire depth of the bed frame, which is 3½ inches at this point. It is placed at 30 1/32 inches from the head area and 11/32 inch from the outer side surface of the frame.

9B is a round 13/16 inch in diameter hole that extends down through the entire depth of the bed frame, which is 3½ inches at this point. It is placed at 53 1/32 inches from the head area and 11/32 inch from the outer surface area of the frame.

10A is a round 13/16 inch in diameter hole that extends down through the entire depth of the bed frame, which is 3½ inches at this point. It is placed at 30 1/32 inches from the head area and 11/32 inch from the outer side surface of the bed frame.

10B is a round 11/32 inch in diameter hole that extends down through the entire depth of the bed frame, which is 3½ inches at this point. It is placed at 53 1/32 inches from the head area and 11/32 inch from the outer side surface of the bed frame.

FIG. 5

11A and 11B are each round ¾ inch in diameter and 5 inch long pegs with rounded bottoms which form the lower 5 inches of a headboard piece which is 34 inches wide by 24 inches high and ¾ inch thick. They are placed at 7 15/16 inches to 8 11/16 inches from each side surface of the headboard piece.

FIG. 6

12A and 12B are each round ¾ inch in diameter and 5 inch long pegs with rounded bottoms which form the lower 5 inches of a removable side-rail piece. 12 B will be placed at the anterior edge of the side-rail. 12A will be placed at 20 inches to 20¾ inches from the anterior edge. This side-rail piece will have a total height of 24 inches and a total length of 28 inches.

FIG. 7

13A will be the same as 12A. 13B will be the same as 12B.

FIG. 8

14A and 14B are each round ¾ inch in diameter and 4 inch long pegs with rounded bottoms which form the lower 4 inches of a removable side-rail piece. 14A will continue down along the anterior edge of the piece and 14B will continue down along the posterior edge of the piece. Side-rail piece will have a total height of 20 inches and a total length of 23¾ inches.

FIG. 9

15A is the same as 14A. 15B is the same as 14B.

FIG. 10

16 is the base section of an air mattress. This section is 34 inches by 80 inches and inflates to a thickness of 2 inches.

FIG. 11

17A and 17B are intermediate sections of the air mattress which will be placed along opposite sides and on top of the base section. They are each 14 inches by 80 inches and inflate to a height of 4 inches.

FIG. 12

18 is a section of the air mattress that will provide back support when inflated. It will be upper-most on the air mattress.

FIG. 13 shows how the air mattress sections will fit together when placed on the bed frame.

FIG. 14 is a over-head view of the bed-pan. FIG. 15 is a side-view.

19 is the bed-pan. It will be generally oval in shape, with an opening of 10½ inches by 4 inches. It will have a depth of 2½ inches and a rounded handle 5 inches long and 1 inch in diameter. It will have a 1½ inch splash-guard section on the top placed between the opening and the handle.

FIG. 16

20 is a web-laying device which will form the facing surface of the disposable bed-pad into a shape which could be described as quilted or an egg-crate shape.

21 is a section of the web-laying device which is a recessed area, rounded in shape, 15/16 inch in diameter and ¼ inch deep.

22 is a spacing bar which will be ⅛ inch in width and be placed within the web-laying device at intervals of 12 inches.

### DETAILED DESCRIPTION OF THE INVENTION

This invention comprises a bed, bed-pad, and bed-pan designed for use when caring for an adult with incontinence or limited mobility in the home setting. The bed frame, with removable side-rails and headboard, will be made of moulded plastic. This will make it less expensive than hospital beds. It will be lighter in weight than hospital beds currently in use and could be packaged to be purchased from a retail store.

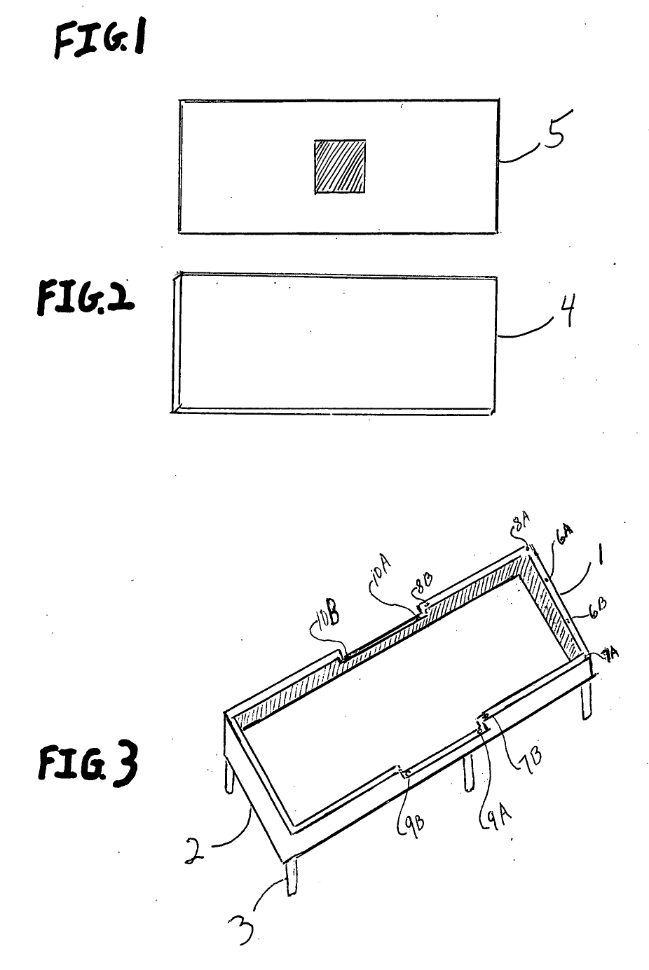

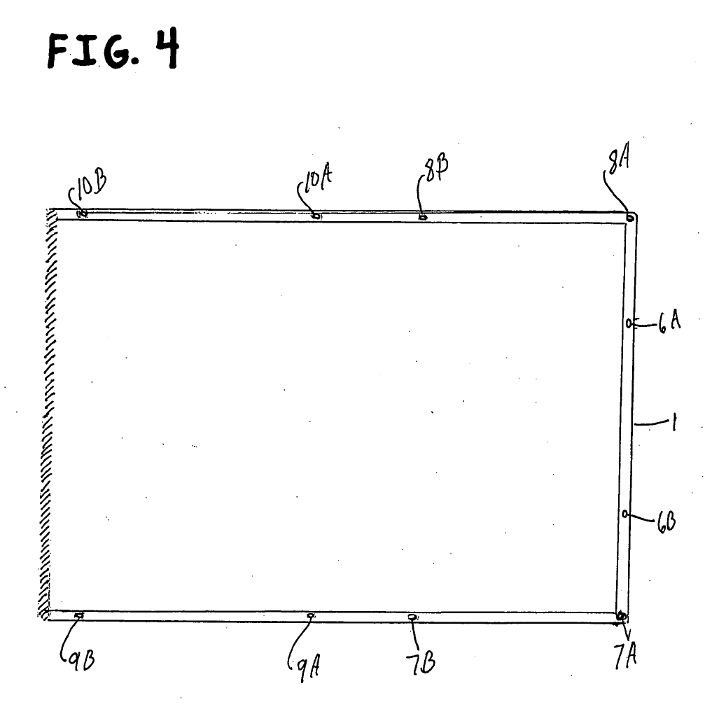

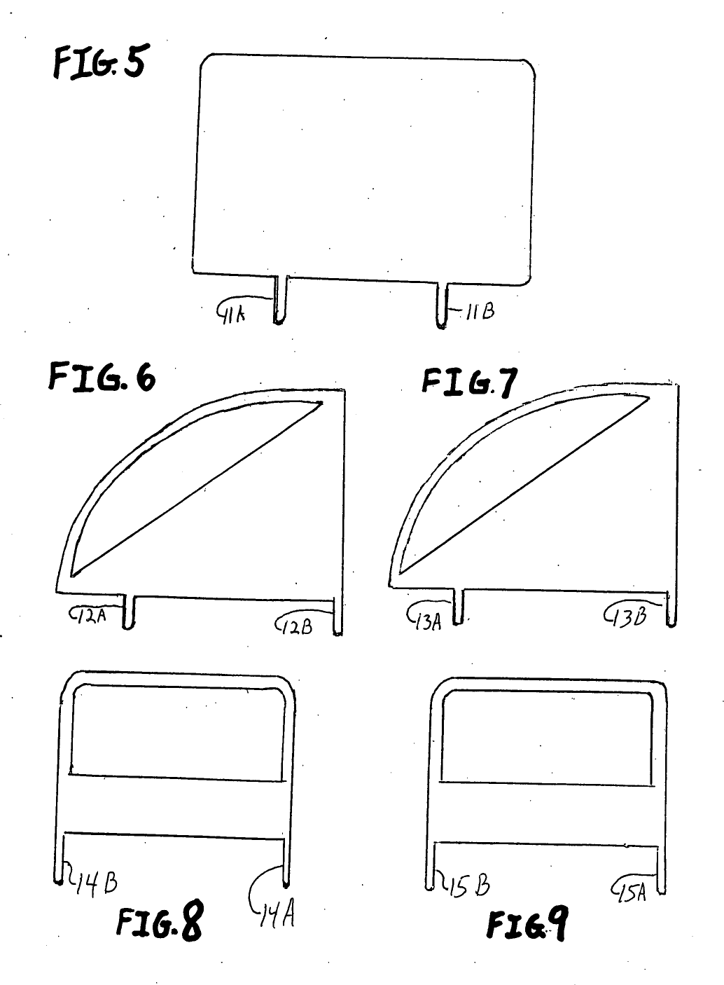

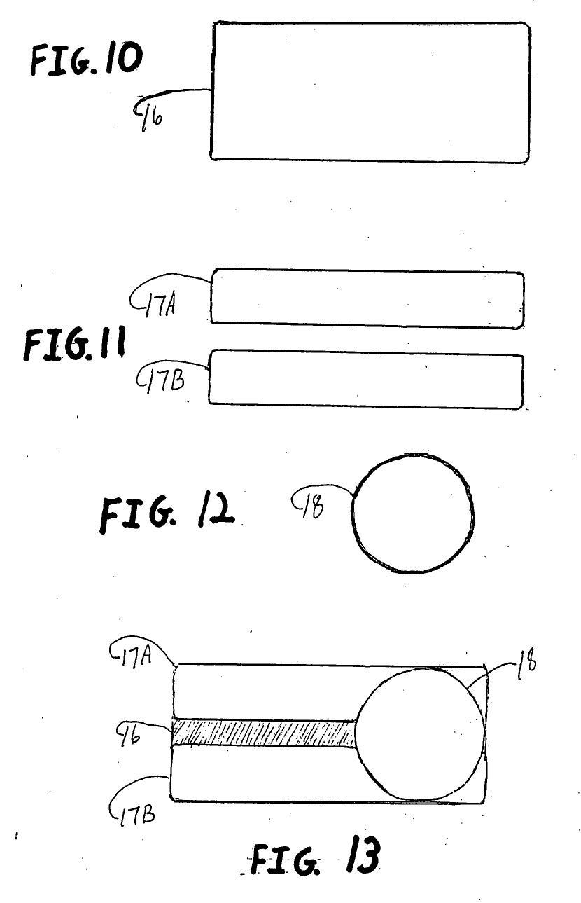

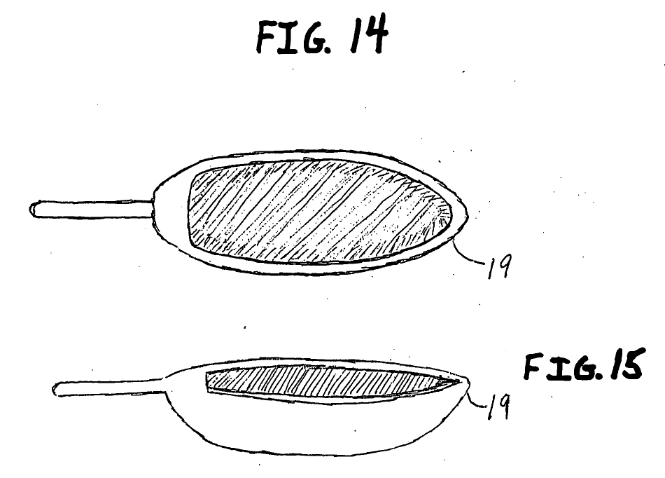

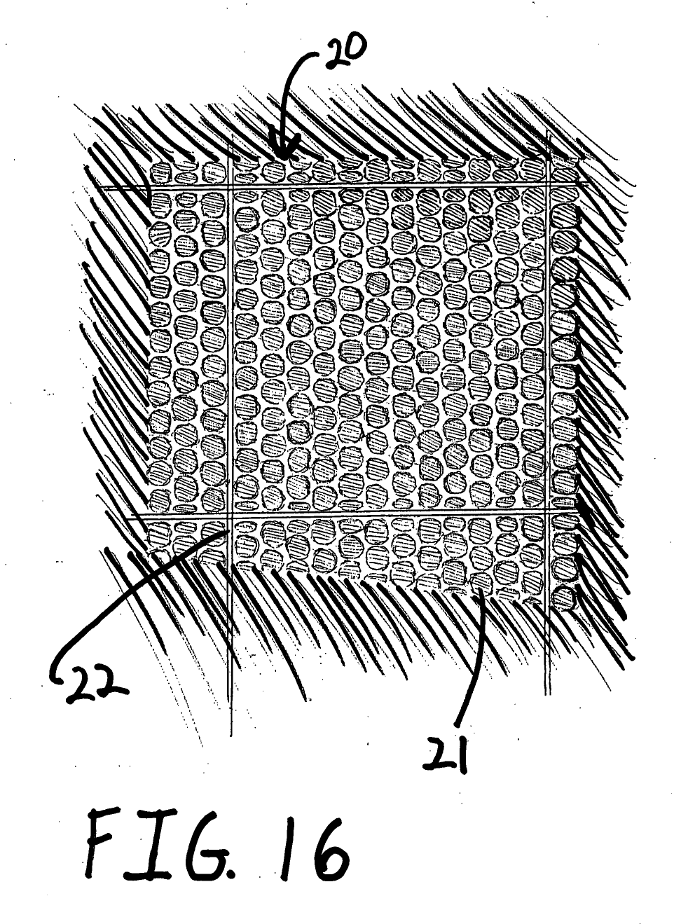

The bed frame will be a single piece of molded plastic that is 37 inches wide and 83 inches long. The base area of the frame will be 37 inches by 83 inches and 1 inch thick. The sides will extend up over the base area and have a thickness of 1½ inches all around the perimeter of the bed frame. FIG. 3 is a drawing of the frame with legs on. The head area of the frame will extend 8 inches up over the base. It will have 2 holes (FIGS. 4, 6A and 6B) that will be used for placement of a headboard piece shown in FIG. 5. The holes will be round, 13/16 inch in diameter and 5¼ inches deep. They will be placed at 11/32 inch from the anterior surface of the head area and at 9 13/32 inches to 10 7/32 inches from each side surface of the frame. The headboard piece will have two pegs on the bottom. (FIGS. 5, 11A and 11B) The two pegs will be rounded ¾ inch in diameter and 5 inches long. They will be placed at 7 15/16 inches to 8 11/16 inches from each side surface of the headboard piece. The headboard piece will be 34 inches long and have a height of 24 inches, including the two 5 inch pegs on the bottom.

The first 29½ inches from the anterior surface of the head area, on each side of the bed will also extend up 8 inches over the base. There will be holes on each side at 17/32 inch to 1 11/32 inch from the anterior surface of the head area. These holes will each be at 11/32 inch from the side surface of the frame. These holes will be round, 13/16 inch in diameter and 5¼ inch deep. (FIGS. 4, 7A and 8A). There will be similar holes on each side at 20 17/32 inches to 21 11/32 inches.(FIGS. 4, 7B and 8B) These holes will be used for placement of side rails which provide safety from falling out of bed when the back support section of the air mattress is inflated. FIG. 6, 12A, 12B and FIG. 7, 13A, 13B shows these sections with pegs. There will be 2 pegs on the bottom of each side-rail. The pegs are round, ¾ inch in diameter, and 5 inches in length with rounded bottoms. The side-rails will be easy to put into place and remove. These side rails have a total height of 24 inches, including the 5 inch pegs on the bottom. The total length of each rail is 28 inches. They will made with a triangular shape and a 1 inch wide strip shaped in an arc from top to the bottom on the posterior side. The solid triangular shaped area of the side rails will contain the air mattress section which can be inflated for back support. The 1 inch wide arc will provide safety from falling out of bed while sitting up, and allow for vision to sides and air-flow.

The next 25 inches from the anterior surface of the head area, on each side of the bed will have sides that extend up 2½ inches from the base. This will allow for ease of getting in and out of bed. There will be round, 13/16 inch in diameter holes that will extend down through the base of the bed. These will be placed at 30 1/32 to 30 27/32 inches from the anterior surface of the head area on each side at 11/32 from the side surface of the frame. (FIGS. 4, 9A and 10A) There will be similar holes placed on each side at 53 1/32 to 53 27/32 inch from the anterior surface of the head area. (FIGS. 4, 9B and 10B) These holes will be used for placement of side rails with pegs. (FIG. 8,14A, 14B) and (FIG. 9, 15A, 15B) These two side rails will each be 20 inches high including 4 inch long and ¾ inch in diameter round pegs with rounded bottoms. They will each be 23¾ inches in length. The lower 4 inches of each side rail will consist of two ¾ inch in diameter round pegs which are 4 inches long extending down on each end of the side-rail. The next 5½ inches extending up and including the entire length of the side rail will be in the shape of a rectangle 5½ inches by 23¾ inches and ¾ inch thick. The upper 10.5 inches of each side rail will be a 1 inch wide and ¾ inch thick strip which extends up and across the entire length of each rail and is rounded at the corners. The side rails will be easy to put in place and remove.

The last 28.5 inches of the bed will have a thickness of 1½ inches on the sides and the foot area. This area of the frame will extend up 8 inches over the base area.

The bed frame will have 6 molded plastic legs each 18 inches long and 1½ inches in diameter with rounded shape and tips that resist sliding over the surface area of a floor.(FIG. 3, 3) The legs will attach to the frame at the 4 corners of the frame and at 38 to 39½ inches from the head area, on each side of the frame. The 6 legs will have a spirally grooved solid cylinder shaped into the top 2 inches of each leg. On the underside of the bed frame, at the 4 corners and at 38 to 39½ inches from the head area of the bed, on each side, there will be a correspondingly grooved hollow cylinder into which the top of a leg will fit. The legs will easily screw on when the bed is being set up for use.

There is an air mattress to be placed over the base area of the bed frame and within the perimeter walls of the frame. (FIG. 13, 16 17A 17B 18) This air mattress will have 4 sections which can be inflated separately using a conventional portable electric powered air pump which can be plugged into a regular household electrical outlet. Said air pump, which will attach to the air valve members of the air mattress, will be included with the bed. FIG. 10 is the base section of the air mattress. This section has top, bottom, and perimeter walls and also has air valve members being conventionally disposed in the perimeter wall, and further having an air chamber disposed between the top, bottom, and perimeter walls. The perimeter wall of the base section is generally an endless strip being disposed along the edges of the top and bottom walls and has a width which is generally uniform throughout. This section will inflate to a height of about 2 inches. The perimeter wall of this section forms an area that is 80 inches in length and 34 inches in width.

There will be two intermediate sections which will be disposed upon and conventionally connected to the base section. They will span the length of the air mattress and be be disposed along each side. These sections will each have a perimeter wall which forms an area 80 inches in length and 14 inches in width. Each will inflate to a height of about 4 inches. (FIGS. 11, 17A and 17B) Each will have air valve members being conventionally disposed in the perimeter wall, and further have an air chamber disposed between the top, bottom, and perimeter walls. These sections can be inflated to aid with turning and toileting.

The uppermost section of the air mattress will be round in shape when inflated. It will inflate to a height and diameter of 34 inches. (FIG. 12, 18) It will have an outer layer with air valve members being conventionally disposed and protruding through, and further having an air chamber disposed within the outer layer. This section will be disposed upon the base section and the intermediate sections. It will be conventionally attached to the base section at 16 to 18 inches from the portion of the base section perimeter wall that will be placed closest to the head area of the frame. This area where it is conventionally attached to the base section will extend 1 inch from the midline area of the base section towards each side, thus forming a 2 inch by 2 inch area of attachment to the base section. This section can be inflated for back support.

There will be a foam mattress 80 inches by 34 inches and 2½ inches thick that will be placed over the air mattress on the bed frame. This mattress will comprise a 2 inch thick section of foam (FIG. 2, 4) and a ½ inch thick section of foam. (FIG. 1, 5) The ½ inch thick section of foam will have a 12 inch by 12 inch section cut out of the center area. The two mattress sections will be bonded together and the ½ inch section will be on top when placed on the bed frame. The 12 inch by 12 inch and ½ inch deep recessed area will be a placement area for a bed-pad. The foam mattress will have a cover made from a blend of nylon and polyurethane. The cover will be soft to the touch and water-resistant. It will have a sewn-in pocket 12 inches by 12 inches and ½ inch deep that will be placed so that it will fit into the recessed bed-pad placement area. The cover will be washable and have a zipper on the side to allow removal.

A bed-pan will be included with the bed. (FIG. 14, 19) The bed-pan will be made of molded plastic. It will be generally oval in shape with an opening of 10½ inches long and 4 inches wide. At the top of the pan, the sides will be ¼ to ½ inch thick with rounded edges. The rounded top edge of the bed-pan will taper to a thickness of about 1/16 inch to ⅛ inch at the bottom. The sides will be rounded in shape and the depth will be 1½ inches. The pan will have a handle 5 inches long and 1 inch in width with a rounded shape. There will be a 1½ inch splash-guard section on the top area of the pan located between the opening and the handle.

When using the bed-pan, one of the side air mattress sections could be inflated to help with turning. The bed pan could then be put in place. Then the opposite side air mattress section could be inflated. This would elevate the body slightly on each side of and over the bed-pan. After use, the bed-pan could be removed by gripping the handle and pulling forward. This would be easier and less messy than bed-pans currently in use. Conventional bed-pans are placed from the side, and after use, the person must turn or be turned to the side again for removal of the bed-pan. This often causes the contents of the bed-pan to spill out on to the bed. Also, if a person desired to sit up while using the bed-pan, the back rest section of the air mattress could be inflated.

Disposable bed-pads will be made to fit the bed-pad placement area of the bed. These pads will be 12 inches long and 12 inches wide with a thickness of about ⅜ inch. These pads will be made using a web-laying device which will have a egg-crate or quilted shape. ( FIG. 16, 20) Said egg-crate or quilted shape will be formed by recessed areas in the web-laying device which will be round, 15/16 inch in diameter, and have a depth of ¼ inch. ( FIG. 16, 21) There will be a space of about 1/16 inch between each recessed area. There will be spacer bars ⅛ inch wide placed at intervals of 12 inches within the web-laying device. These spacer-bars will shape the areas which will be cut to form the 12 inch by 12 inch pads.( FIG. 16, 22).

Short fibers will be randomly laid on the web-laying device. This layer will be conveyed to a bonder including a suction means and a bonding agent with surfactant added, preferably an anionic surfactant, will be applied. This layer will be dried. Next a layer of polystyrene beads 0.70 to 1.20 mm in diameter each, and mixed with short fibers for wicking, and treated with surfactant, will be added in quantity enough to bring the total thickness to about 3/16 inch. These beads can be purchased in bulk from a company such as Norstone, Inc. This will be conveyed to a bonder including a suction means and a bonding agent with surfactant added will be applied with a layer of short fibers. This will be dried. The short fibers first placed on the web-laying device will be bonded to the short fibers of the third layer. This will enclose the polystyrene beads with fibers for wicking, forming a egg-crate of quilted shape.

Next a layer of highly porous, loosely compacted, cellulosic fibrous batt is added to bring the total thickness to about ⅜ inch. The batt will then be coated with a hot melt adhesive. No drying time is required after this step because on cooling, the adhesive regains its solid form and cohesive strength. The sheets will be cut into 12 inch by 12 inch squares. Then the under-side of the pads and the sides of the pads will be coated with hot melt adhesive to assure no leakage through the bottom of the pad and seal the sides as well. At this point, the pads will be ready for packaging.

Materials and methods useful in the making of a facing sheet and a cellulosic batt are illustrated in U.S. Pat. No. 3,612,055. The use of hot melt adhesives as a waste barrier is illustrated in U.S. Pat. No. 4,692,161. The addition of polystyrene beads with a wicking fiber and surfactant added, to be used in a top layer of a bed-pad, is a new idea claimed by this invention. The top layer of a bed-pad made as described would allow fluid to pass through while staying relatively dry. There would also be good air-flow to the skin, which is important for evaporation of moisture. Also, the beads would provide a cushioning of bony areas of the body, such as the coccyx.

1. I claim a bed comprising (1) a frame constructed completely or predominantly of molded plastic with removable side-rails, (2) a urethane base foam mattress with a recessed section shaped for placement of a bed pad, (3) an air mattress with inflatable sections to aid in turning and sitting up.

2. I claim a multi-layer disposable bed pad comprising (1) a porous, water wettable facing layer formed in an egg-crate or quilted shape, (2) a layer of polystyrene beads mixed with fibers for wicking and treated with surfactant, (3) a layer of short fibers treated with a bonding agent mixed with a surfactant, which will bond with the facing layer in such a way as to enclose the polystyrene beads with wicking fibers into pockets forming an egg-crate or quilted shape, (4) a layer of highly porous, loosely compacted cellulosic fibrous batt, (5) a hot-melt adhesive coating or other fluid impervious barrier applied to the sides and bottom of the pad.

3. I claim a bed pan comprising (1) a generally oval shape with tapering ends, (2) an upper surface with side edges of ¼ inch to ½ inch in width and rounded edges tapering to 1/16 inch to ⅛ inch in width on the bottom, (3) an open area of 10½ inches long and 4 inches wide at the widest point, with a depth of 2½ inches, (4) a handle 5 inches long and 1 inch wide and rounded, (5) a 1½ inch in length section covering the top of the pan between the open area and the handle.
